(19) United States
(12) Patent Application Publication
(10) Pub. No.: US 2026/0347606 A1
(43) Pub. Date: Nov. 5, 2026

(54) RECYCLABLE MONO-MATERIAL OBJECTS COMPRISING AT LEAST TWO ELEMENTS

(71) Applicant: ARKEMA FRANCE, Puteaux (FR)

(72) Inventors: Karine LOYEN, Serquigny (FR); Thomas PRENVEILLE, Serquigny (FR); Patrick DANG, Serquigny (FR); Amélie NOEL, Serquigny (FR)

(73) Assignee: ARKEMA FRANCE, Puteaux (FR)

(21) Appl. No.: 19/124,543

(22) PCT Filed: Oct. 26, 2023
(86) PCT No.: PCT/FR2023/051692

§ 371 Date: Apr. 25, 2025

(30) Foreign Application Priority Data
Oct. 28, 2022 (FR) FR2211265

(51) Int. Cl. C08L 77/02; B29B 17/04; B29K 77/00; B29K 105/00; B29K 105/26; C08J 11/06

(52) U.S. Cl. CPC C08L 77/02; B29B 17/0404; C08J 11/06; B29B 2017/042; B29K 2077/00; B29K 2105/0085; B29K 2105/0088; B29K 2105/26; C08J 2377/02; C08L 2205/025; C08L 2207/20

(57) ABSTRACT

A mono-material object including at least two elements: at least one first element of a first composition including, by weight, at least 30% of at least one long-chain homopolyamide or of at least one long-chain copolyamide, a copolyamide bearing amide units (Ba1) and polyether units (Ba2) being excluded from said first composition, at least one second element of a second composition including by weight at least 30% of a copolyamide bearing amide units (Ba1) and polyether units (Ba2), said first and second elements being able to adhere at least partially to each other, the at least one long-chain homopolyamide or at least one long-chain copolyamide of the first composition having a C/N ratio greater than or equal to 8, and the copolyamide of the second composition having a C/N ratio of the unit (Ba1) greater than or equal to 6.

### TECHNICAL FIELD

The present patent application relates to recyclable mono-material objects comprising at least two elements, to their manufacturing process and to their recycling process, to the compositions thus obtained and to the use thereof in the manufacture of objects, in particular mono-material objects.

### PRIOR ART

Through a circular economy it is possible to limit waste generation, depletion of the planet's resources, and environmental impact. Particular attention is currently being given to producing objects by means of materials which, after recycling, will have properties sufficient to enable them to be used for high performance applications and not only for lower performance applications such as for street furniture or roads.

In the context of sustainable consumption and production patterns, the recyclability of frequently renewed items such as sports equipment and E&E articles and the quality of the recycled products thus obtained are of particular importance. However, the performance requirements are particularly high for these items.

It is essential to design objects such as sports equipment and E&E articles in such a way that they can be recycled into a very high performance material. It is also important that the products used for manufacturing objects are stable enough to be safely recycled. When thermoplastic polyurethanes (TPU) are recycled, isocyanate formation can be observed by FTIR. Isocyanates are hazardous CMR compounds.

Patent EP 3 081 109 B1 proposes, in order to facilitate their recycling, a sports shoe whose upper part and sole are predominantly or even entirely formed from the same thermoplastic base material. Nevertheless, it appears that difficulties remain in that the recycling product thus obtained has limitations in terms of performance because the density of the parts of the shoe differs according to their respective function.

Patent application WO 2020/201370 A1 proposes a method for recycling such shoes in which the shoe is ground and then melted. Said document is focused, like the previous one, on thermoplastic polyurethanes (TPU). Said international patent application indicates the fact that the TPU degrades with recycling cycles.

Patent application US 2017/0151470 A1 relates to a ball, in particular a football, and to a process for manufacturing and recycling the ball. The ball consists of a bladder, an intermediate layer and an outer layer, the bladder and the two layers consisting of a predominant component by weight of a material of a first material class chosen from polyurethane, polyvinyl chloride, polyethylene, polyamide and polypropylene.

International patent application WO 2021/148148 A1 relates to a lined clothing article which comprises an outer layer, an inner layer and a lining between the two layers.

Each layer contains a predominant amount of a material from the same family chosen from thermoplastic polymers, notably a recycled polyester or a virgin polymer chosen from thermoplastic polyurethanes (TPU), polyamides (PA), polyethylene terephthalate (PET) or polybutylene terephthalate (PBT). Polyesters have the drawback of being very sensitive to hydrolysis.

One aim of the invention is thus to propose a mono-material object whose composition is studied so as to make it possible to obtain, on recycling, a composition that can be used for applications requiring high performance.

It has now been demonstrated that the exclusive combination (excluding additives and fillers) in a mono-material object of a polyamide fraction and of a fraction of polyether block amide (PEBA) fraction affords better maintenance of the properties during recycling.

Specifically, the presence of polyamides in the composition notably affords good resistance to aging and thus to the lifetime of the object and to its recycling process. For its part, the presence of PEBA, which is more flexible, contributes toward improving the mechanical strength of the object throughout its life, before and after recycling.

Thus, according to a first aspect, one subject of the invention is a mono-material object comprising at least two elements:
at least one first element consisting of a first composition comprising, by weight, at least 30%, notably at least 50%, particularly at least 70%, more particularly at least 90%, relative to the total weight of the first element, of at least one long-chain homopolyamide or of at least one long-chain copolyamide,
   said at least one long-chain homopolyamide and said at least one long-chain copolyamide representing, independently of each other, a repeating unit chosen from a unit obtained from the polycondensation of at least one C4-C36 amino acid, a unit obtained from the polycondensation of at least one C4-C36 lactam and an XY unit obtained from the polycondensation:
   of at least one diamine, said diamine being chosen from a linear or branched aliphatic diamine, a cycloaliphatic diamine and a semi-arylaliphatic diamine, or a mixture thereof, and
   of at least one dicarboxylic acid, said diacid being chosen from:
   an aliphatic diacid, a cycloaliphatic diacid and an aromatic diacid,
   said diamine and said diacid comprising from 4 to 36 carbon atoms, advantageously from 6 to 18 carbon atoms,
   a copolyamide bearing amide units (Ba1) and polyether units (Ba2) being excluded from said first composition,
at least one second element consisting of a second composition comprising by weight at least 30%, notably at least 50%, particularly at least 70%, more particularly at least 90%, relative to the total weight of the second element, of a copolyamide bearing amide units (Ba1) and polyether units (Ba2)
   said first and second elements being able to adhere at least partially to each other,
   said at least one long-chain homopolyamide or at least one long-chain copolyamide of the first composition having a C/N ratio greater than or equal to 8, in particular greater than or equal to 9, notably greater than or equal to 10, and said copolyamide of the second composition having a C/N ratio of the amide unit (Ba1) greater than or equal to 6, notably greater than or equal to 8, in particular greater than or equal to 9, notably greater than or equal to 10,
   said object being to the exclusion of a monolayer or multilayer structure for transporting, distributing or storing a fluid.

The inventors thus found, unexpectedly, that the exclusive combination (excluding additives) in a mono-material object of a particular polyamide fraction (or element), namely long-chain polyamides, and of a particular polyether block amide (PEBA) copolyamide fraction (or element), namely PEBAs having a C/N ratio of the amide unit (Ba1) greater than or equal to 6, notably greater than or equal to 8, in particular greater than or equal to 9, notably greater than or equal to 10, allows better maintenance of the properties during recycling.

Specifically, the long-chain polyamides in one of the two compositions and the copolyamides with a particular polyether block amide (PEBA) unit in the other composition offer the best compromise and notably afford good resistance to aging and thus to the lifetime of the object and to its recycling process. They may moreover be safely recycled.

The recycled compositions thus have the advantage of having a low density, good elastic recovery, good fatigue strength, good impact strength, good mechanical tensile properties, good dimensional stability, a stable modulus between −20 °C and 30 °C and good chemical resistance, notably good hydrolysis resistance.

The C/N ratio corresponds to the number of carbon atoms per nitrogen atom in the polyamide or copolyamide.

The term “mono-material object” should be understood to mean an object consisting predominantly of the same material, in this case a long-chain polyamide in one of the two compositions and a copolyamide bearing amide units (Ba1) and bearing polyether units (Ba2), having a C/N ratio of the unit (Ba1) greater than or equal to 6, notably greater than or equal to 8, in particular greater than or equal to 9, notably greater than or equal to 10 in the other composition.

More precisely, the term “mono-material object” should be understood to mean an object comprising at least two elements, with each element consisting of compositions respectively comprising at least one polymer matrix, with said polymer matrix predominantly comprising, i.e. to more than 50% by weight, relative to its total weight, respectively either a long-chain homopolyamide or copolyamide as defined according to the invention, or a copolyamide bearing amide units (Ba1) and bearing polyether units (Ba2) as defined according to the invention.

For the purposes of the invention, the mono-material object may in particular be an object comprising at least two elements, with each element being mono-material, i.e. each element predominantly consisting of the same material as defined according to the invention.

The term “polymer matrix” is intended to denote the part of the composition consisting exclusively of polymers, i.e. the non-polymeric fillers and additives are excluded here.

Preferably, said polymer matrix respectively comprises at least 60% by weight, preferably at least 80% by weight, preferably at least 90% by weight, advantageously at least 95% by weight, or even 100% by weight, of either a long-chain homopolyamide or copolyamide as defined according to the invention, or a copolyamide bearing amide units (Ba1) and polyether units (Ba2) as defined according to the invention.

According to one embodiment, for the purposes of the present invention, a “mono-material object” is an object comprising at least two elements, with each element consisting of compositions predominantly comprising, i.e. to more than 50% by weight, relative to their total weight,

respectively either a long-chain homopolyamide or copolyamide as defined according to the invention, or a copolyamide bearing amide units (Ba1) and polyether units (Ba2) as defined according to the invention.

Preferably, each element consists of compositions comprising at least 80% by weight, preferably at least 90% by weight, advantageously at least 95% by weight, or even 100% by weight, respectively either a long-chain homopolyamide or copolyamide as defined according to the invention, or a copolyamide bearing amide units (Ba1) and polyether units (Ba2) as defined according to the invention.

According to one embodiment, a mono-material object of the invention is an object comprising at least two elements, with each element consisting of compositions comprising less than 20% by weight, preferably less than 10% by weight, for example less than 5% by weight, for example less than 3% by weight, in particular 0% by weight, relative to their total weight, of short-chain polyamides, i.e. polyamides having a C/N ratio strictly less than 8, notably less than or equal to 7, in particular less than or equal to 6.

According to one embodiment, a mono-material object of the invention comprises less than 20% by weight, preferably less than 10% by weight, for example less than 5% by weight, for example less than 3% by weight, in particular 0% by weight, relative to its total weight, of short-chain polyamides, i.e. polyamides having a C/N ratio strictly less than 8, notably less than or equal to 7, in particular less than or equal to 6.

In a first variant, the mono-material objects may be, but are not limited to, the following:
an electronic article, in particular a watch, a telephone case, headphones, earphones, a loudspeaker, a keyboard, a mouse, a telephone charger, preferentially a telephone case, headphones, earphones, a loudspeaker, a keyboard, a mouse, a telephone charger,
an article of clothing, in particular a jacket, trousers, a T-shirt or socks,
an optical article, in particular prescription glasses, sunglasses, children's glasses, sports glasses and a ski mask, augmented reality/virtual reality goggles,
a household electrical article, in particular a small household electrical appliance, a household electrical article accessory (bowl, mixing paddle, food container), a flask, a food container,
a cosmetic article, in particular cosmetic packaging such as a bottle, a fragrance, makeup packaging, skincare packaging, a display article, a hairbrush,
a sports article, in particular a surfboard (and its accessories such as a leash or daggerboards), a bicycle, a bicycle article such as a saddle or pedal, a helmet, a ski boot, skis, ski poles, a ski binding and a snowboard (excluding metal), a golf club, any type of racket, in particular a tennis racket, protective equipment such as a shin guard, elbow pad, etc., a hockey cross (on grass or ice), a roller skate, diving flippers,
a luggage article, in particular a suitcase, a rucksack and a handbag,
a stationery article, in particular pens,
a toy,
furniture, and
motor vehicle parts,
(with the exclusion of a monolayer or multilayer structure for transporting, distributing or storing a fluid).

The expression “said object being to the exclusion of a monolayer or multilayer structure for transporting, distributing or storing a fluid” means that the monolayer or multilayer structures for transporting, distributing or storing a fluid, notably for an apparatus with a thermal or electric motor such as an aeroplane, a drone, an aircraft, a lorry or a motor vehicle, are excluded from said object.

In one embodiment of this first variant, the mono-material objects correspond to all those described in the list of this first variant with the exception of at least one of those described in this same list and with the exclusion of a monolayer or multilayer structure for transporting, distributing or storing a fluid.

Needless to say, at least said mono-material object corresponds to at least one of those described in said list of this first variant.

In a second variant, the mono-material objects may be an electronic article, a textile article, an optical article, a household electrical article, a cosmetic article, a sports article, a stationery article, a luggage article, a toy, furniture and motor vehicle parts (excluding a monolayer or multilayer structure for transporting, distributing or storing a fluid).

In one embodiment of this second variant, the mono-material objects correspond to all those described in the list of this second variant with the exception of at least one of those described in this same list and with the exclusion of a monolayer or multilayer structure for transporting, distributing or storing a fluid.

Needless to say, at least said mono-material object corresponds to at least one of those described in said list of this second variant.

In a third variant, the mono-material objects may be an electronic article, a textile article, an optical article, a household electrical article, a cosmetic article, a sports article, a stationery article, a luggage article, a toy or furniture.

In one embodiment of this third variant, the mono-material objects correspond to all those described in the list of this third variant with the exception of at least one of those described in this same list and with the exclusion of a monolayer or multilayer structure for transporting, distributing or storing a fluid.

Needless to say, at least said mono-material object corresponds to at least one of those described in said list of this third variant.

Said object is excluded from being a monolayer or multilayer structure for transporting, distributing or storing a fluid.

The term “fluid” combines any gas, in compressed form, in liquid form or cryocompressed, and notably hydrogen, natural gas, LPG, LNG, compressed air, nitrogen, oxygen, and also a heat transfer fluid, in particular a refrigerant chosen from the following compounds: hydrocarbons, hydrofluorocarbons, ethers, hydrofluoroethers, CO2, NH3, SO2 and fluoroolefins, notably R134, R-1234yf or R-1234ze, in particular R-1234yf or R-1234ze, or a gas used in motor vehicles, in particular air or a liquid used in motor vehicles, in particular water, an oil, a brake fluid, a urea solution, a glycol-based coolant, a transmission oil cooler (TOC), fuels, notably diesel, gasoline, more particularly alcohol-blended gasoline or LPG.

In one embodiment, a shoe, a ball, a jacket, a seat, notably a motor vehicle seat, a toothbrush or a rucksack are excluded from the mono-material objects of the invention.

Preferably, the invention relates to mono-material objects which may be obtained by injection molding.

According to one embodiment, the mono-material object of the invention is different from a multilayer structure comprising a textile layer, a film and optionally a hot-melt adhesive composition between the textile layer and the film.

According to one embodiment, the mono-material object of the invention is different from a multilayer structure comprising (i) a textile layer comprising at least one polymer chosen from a polyamide and a copolymer comprising polyamide blocks and polyether blocks, and also combinations thereof, and (ii) a film comprising at least one copolymer comprising polyamide blocks and polyether blocks comprising polyethylene glycol blocks, the polyethylene glycol blocks representing at least 40% by mass relative to the mass of the film, in which the film adheres to the textile layer via a copolyamide.

According to one embodiment, the mono-material object of the invention is different from a multilayer structure comprising (i) a film composed of PA11/PEG6 (40/60 by weight) where Mn (PA11) equals 1000 g/mol and Mn (PEG) equals 1500 g/mol and Tm equals 150 °C and (ii) a film composed of PA6/6. 12/11/PEG12 (24.5/20.9/24.5/30.1 by weight respectively) in which Mn (PA) equals 2000 g/mol and Mn (PEG) equals 600 g/mol and Tm equals 100 °C.

According to one embodiment, the mono-material object of the invention is different from a bandage, a gauze, a cloth, a carpet, a rug, an upholstery covering, a surface covering, a passenger compartment covering, a sofa, a curtain, bedding, a mattress, a pillow, a garment, notably a sports garment or a medical garment.

According to one embodiment, the mono-material object of the invention is different from a shoe sole, in particular different from a sports shoe sole.

In one embodiment, at least 50% by weight of long-chain polyamide or long-chain copolyamide and polyamide bearing amide units (Ba1) in the copolyamide is present in each of the two elements relative to the total weight of the composition of each element.

In other words, the sum by weight of long-chain polyamide or long-chain copolyamide in the first element and polyamide bearing amide units (Ba1) in the second element is at least 50% relative to the total weight of the two compositions of each element.

In another embodiment, the matrix of each of the two elements (fillers and additives excluded) consists of 60% by weight, advantageously 80% by weight, preferably 100% by weight of long-chain polyamide or long-chain copolyamide for the first element or of polyamide bearing amide units (Ba1) for the second element.

The term “element” denotes each of the things, the combination of which forms another thing, a whole, namely in the present invention a mono-material object.

In particular, an element denotes a component, a constituent, a fragment, a part, a piece or unit which constitutes the mono-material object.

The expression “said first and second elements possibly adhering at least partially to each other” means that said first and second elements may or may not adhere to each other.

In one embodiment, said first and second elements are free of adhesion to each other.

In another embodiment, said first and second elements adhere to each other, at least partially, notably entirely.

The term “adheres” means that said first and second elements are placed one against the other or applied one against the other, at least partially and notably by bonding, clip-fastening, overmolding, thermoforming, screwing, sewing, welding or riveting.

Needless to say, said first composition, which comprises a long-chain homopolyamide and copolyamide, may also comprise impact modifiers and/or plasticizers and/or fillers and/or additives.

Needless to say, said second composition, which comprises a copolyamide bearing amide units (Ba1) and polyether units (Ba2), may also comprise impact modifiers and/or plasticizers and/or fillers and/or additives.

Needless to say, said third composition described below, which comprises a long-chain homopolyamide and a long-chain copolyamide or a copolyamide bearing amide units (Ba1) and polyether units (Ba2) or a mixture of the two, may also comprise impact modifiers and/or plasticizers and/or fillers and/or additives.

As regards the long-chain homopolyamide and copolyamide of the composition of the first element and of the third element.

The nomenclature used to define polyamides is described in the standard ISO 1874-1:2011 “Plastics—Polyamide (PA) molding and extrusion materials—Part 1: Designation”, in particular on page 3 (Tables 1 and 2), and is well known to a person skilled in the art.

Said long-chain homopolyamide and copolyamide is a polyamide having a C/N ratio, i.e. having an average number of carbon atoms per nitrogen atom, greater than or equal to 8, in particular greater than or equal to 9, notably greater than or equal to 10.

In a first variant of the invention, the repeating unit is a unit obtained from the polycondensation of at least one C4-C36 amino acid (or aminocarboxylic acid),

Advantageously, said aminocarboxylic acid comprises from 9 to 12 carbon atoms. It may thus be chosen from 9-aminononanoic acid (denoted 9), 10-aminodecanoic acid (denoted 10), 11-aminoundecanoic acid (denoted 11) and 12-aminododecanoic acid (denoted 12); advantageously, the aminocarboxylic acid is 11-aminoundecanoic acid.

In a second variant of the invention, the repeating unit is a unit obtained from the polycondensation of at least one C4-C36 lactam.

Advantageously, the lactam comprises from 9 to 12 carbon atoms. It may thus be chosen from decanolactam (denoted 10), undecanolactam (denoted 11) and laurolactam or lauryllactam (denoted 12); advantageously, the lactam is lauryllactam.

However, it is entirely possible to envisage using a mixture of two or more aminocarboxylic acids, a mixture of two or more lactams, but also a mixture of one, two or more aminocarboxylic acids with one, two or more lactams.

More particularly preferably, the repeating unit is obtained from a single aminocarboxylic acid or a single lactam.

### Repeating Unit XY

The repeating unit XY is a unit obtained from the polycondensation of at least one diamine, said diamine being chosen from a linear or branched aliphatic diamine, a cycloaliphatic diamine and a semi-arylaliphatic diamine, or a mixture thereof, and
of at least one dicarboxylic acid, said diacid being chosen from:
an aliphatic diacid, a cycloaliphatic diacid and an aromatic diacid or a mixture thereof,

The molar proportions of diamine and of dicarboxylic acid are preferentially stoichiometric.

Said diamine comprises from 4 to 36 carbon atoms, advantageously from 6 to 18 carbon atoms.

According to one embodiment, said diamine comprises from 6 to 12 carbon atoms.

In the case where the diamine used to produce this repeating unit XY is an aliphatic diamine which has a linear main chain, this linear main chain may, where appropriate, include one or more methyl and/or ethyl substituents; in this latter configuration, it is referred to as a “branched aliphatic diamine”. In the case where the main chain does not include any substituents, the aliphatic diamine is referred to as “linear aliphatic diamine”.

Whether or not it includes methyl and/or ethyl substituents on the main chain, the aliphatic diamine used to obtain this repeating unit XY comprises from 4 to 36 carbon atoms, advantageously from 6 to 18 carbon atoms, notably from 9 to 18 carbon atoms.

When this diamine is a linear aliphatic diamine, it then corresponds to the formula H2N—(CH2)x-NH2 and may be chosen, for example, from butanediamine, pentanediamine, hexanediamine, heptanediamine, octanediamine, nonanediamine, decanediamine, undecanediamine, dodecanediamine, tridecanediamine, tetradecanediamine, hexadecanediamine, octadecanediamine and octadecenediamine. The linear aliphatic diamines which have just been mentioned can be all biobased within the meaning of the standard ASTM D6866.

When this diamine is a branched aliphatic diamine, it can in particular be 2-methylpentanediamine, 2-methyl-1,8-octanediamine or (2,2,4- or 2,4,4-)trimethylhexanediamine.

The cycloaliphatic diamine may be chosen, for example, from bis(3,5-dialkyl-4-aminocyclohexyl)methane, bis(3,5-dialkyl-4-aminocyclohexyl)ethane, bis(3,5-dialkyl-4-aminocyclohexyl)propane, bis(3,5-dialkyl-4-aminocyclohexyl)butane, bis(3-methyl-4-aminocyclohexyl)methane or 3′-dimethyl-4,4′-diaminodicyclohexylmethane commonly referred to as “BMACM” or “MACM” (and denoted B hereinafter), p-bis(aminocyclohexyl)methane commonly referred to as “PACM” (and denoted P hereinafter), isopropylidenedi(cyclohexylamine) commonly referred to as “PACP”, isophoronediamine (denoted IPD hereinafter) and 2,6-bis(aminomethyl)norbornane commonly referred to as “BAMN” or bis(aminomethyl)cyclohexane, commonly known as “BAC”.

A nonexhaustive list of these cycloaliphatic diamines is given in the publication “Cycloaliphatic Amines” (Encyclopedia of Chemical Technology, Kirk-Othmer, 4th edition (1992), pp. 386-405).

When this diamine is a semi-arylaliphatic diamine, it is chosen, for example, from 1,3-xylylenediamine and 1,4-xylylenediamine.

The dicarboxylic acid comprises from 4 to 36 carbon atoms, advantageously from 6 to 18 carbon atoms and notably from 6 to 12 carbon atoms.

When the dicarboxylic acid is aliphatic, it may be chosen from linear or branched aliphatic dicarboxylic acids.

When the dicarboxylic acid is aliphatic and linear, it can be chosen from succinic acid (4), pentanedioic acid (5), adipic acid (6), heptanedioic acid (7), octanedioic acid (8), azelaic acid (9), sebacic acid (10), undecanedioic acid (11), dodecanedioic acid (12), brassylic acid (13), tetradecanedioic acid (14), hexadecanedioic acid (16), octadecanedioic acid (18), octadecenedioic acid (18), eicosanedioic acid (20), docosanedioic acid (22) and fatty acid dimers containing 36 carbons.

The abovementioned fatty acid dimers are dimerized fatty acids obtained by oligomerization or polymerization of unsaturated monobasic fatty acids having a long hydrocarbon chain (such as linoleic acid and oleic acid), as notably described in EP 0 471566.

When the dicarboxylic acid is aromatic, it may be chosen from terephthalic acid (denoted T), isophthalic acid (denoted I) and a naphthalenic acid (denoted N).

In one embodiment, the composition of the first element consists of a single homopolyamide.

In another embodiment, the homopolyamide of the composition of the first element is an aliphatic semicrystalline homopolyamide.

For the purposes of the invention, the term “semicrystalline homopolyamide” means a material which is generally solid at room temperature and which softens during a temperature increase, in particular after passing its glass transition temperature (Tg), and which can melt sharply when passing its “melting temperature” (Tm), and which becomes solid again when the temperature decreases below its crystallization temperature.

For the purposes of the invention, the semicrystalline homopolyamide has a melting temperature (Tm) according to the standard ISO 11357-3:2013 by DSC, and an enthalpy of crystallization during the cooling step at a rate of 20 K/min by DSC according to the standard ISO 11357-3 of 2013 which is greater than 25 J/g, preferably greater than 40 J/g.

The Tg, the Tc and the Tm are determined by differential scanning calorimetry (DSC) according to the standards 11357-2:2013 and 11357-3:2013 respectively.

The number-average molecular mass Mn of said semicrystalline homopolyamide is preferably in a range extending from 10 000 to 85 000, notably from 10 000 to 60 000, preferentially from 10 000 to 50 000, even more preferentially from 12 000 to 50 000. These Mn values can correspond to inherent viscosities of greater than or equal to 0.8, as determined in m-cresol according to the standard ISO 307:2007 but changing the solvent (use of m-cresol in place of sulfuric acid and the temperature being 20 °C).

Said at least one homopolyamide or said at least one copolyamide comprise reactive functions chosen from primary amines or carboxylic acids.

Said at least one homopolyamide or said at least one copolyamide preferably has an amine (NH2) function concentration of from 0.020 meq/g to 2.0 meq/g, preferably from 0.035 meq/g to 0.5 meq/g, more preferably from 0.040 to 0.2 meq/g. The concentration of NH2 function may be measured by means of a potentiometric assay.

This assay may, for example, be performed as follows: the PAs are first dissolved in m-cresol at 80 °C

and the terminal NH2 functions are then assayed using a perchloric acid solution.

Said at least one homopolyamide or said at least one copolyamide preferably has a COOH function concentration of from 0.020 meq/g to 2.0 meq/g, preferably from 0.035 meq/g to 0.5 meq/g, more preferably from 0.040 to 0.2 meq/g. The concentration of COOH functions may be determined by potentiometric analysis. A measurement protocol is detailed

in the article “Synthesis and characterization of poly(copolyethers-block-polyamides)-II. Characterization and properties of the multiblock copolymers”, Marechal et al., Polymer, Volume 41, 2000, 3561-3580.

The homopolyamide or copolyamide of the first composition and the polyamide bearing units (Ba1) of the second composition may be identical or different.

In a first variant, only one of the two compositions comprises a filler, the other not comprising any.

In a second variant, the first composition and the second composition comprise the same polyamide, in particular a PA11.

More precisely, according to this variant, the first composition and the copolyamide bearing amide units (Ba1) and polyether units (Ba2) of the second composition comprise the same polyamide, in particular a PA11. In other words, the polyamide part of the copolyamide bearing amide units (Ba1) and polyether units (Ba2) of the second composition is, according to this embodiment, identical to the polyamide of the first composition, in particular a PA11.

In a third variant, at least 10% by weight of the units, in particular at least 30% by weight, constituting said at least one homopolyamide or said at least one copolyamide of the first composition and said polyamide bearing units (Ba1) of the second composition are identical; in particular, said units are PA11 units.

In a fourth variant, the first composition and the second composition comprise the same polyamide, in particular a PA11.

In one embodiment of these four variants, said long-chain homopolyamide of the first composition is chosen from:
polyamide 11 (PA11), polyamide 12 (PA12), polyamide 1010 (PA1010), polyamide 1012 (PA1012), polyamide 1212 (PA1212), or a mixture thereof or a copolyamide thereof, in particular PA11 and PA12.

More particularly, said long-chain homopolyamide is chosen from: polyamide 11 (PA11), polyamide 12 (PA12), polyamide 1012 (PA1012), polyamide 1212 (PA1212), or a mixture thereof or a copolyamide thereof, in particular PA11 and PA12.

Even more particularly, said long-chain homopolyamide is polyamide 11.

In another embodiment of these four variants, said long-chain copolyamide is chosen from 11/10T, 11/BI, 11/B10, 11/BI/BT, 12/BI, 1010/B10 or a mixture thereof.

B corresponds to 3,3′-dimethyl-4,4′-diaminodicyclohexylmethane, also commonly known as BMACM or MACM.

PACM corresponds to bis(p-aminocyclohexyl)methane, also commonly known as P.

PACM is preferentially PACM20, which is a mixture of isomers and contains about 20% of the trans-trans-PACM isomer, or PACM50, which is a mixture of isomers and contains about 50% of the trans-trans-PACM isomer.

In yet another embodiment of these four variants, said polyamide bearing amide units (Ba1) of the second composition is chosen from:
polyamide 11 (PA11), polyamide 12 (PA12), polyamide 1010 (PA1010), polyamide 1012 (PA1012), polyamide 1212 (PA1212), or a mixture thereof or a copolyamide thereof, in particular PA11 and PA12.

More particularly, said polyamide bearing amide units (Ba1) of the second composition is chosen from: polyamide 11 (PA11), polyamide 12 (PA12), polyamide 1012 (PA1012), polyamide 1212 (PA1212), or a mixture thereof or a copolyamide thereof, in particular PA11 and PA12.

Even more particularly, said polyamide bearing amide units (Ba1) of the second composition is polyamide 11.

In yet another embodiment of these four variants, said long-chain homopolyamide of the first composition is chosen from:
polyamide 11 (PA11), polyamide 12 (PA12), polyamide 1010 (PA1010), polyamide 1012 (PA1012), polyamide 1212 (PA1212), or a mixture thereof or a copolyamide thereof, in particular PA11 and PA12, and
said polyamide bearing amide units (Ba1) of the second composition is chosen from:
polyamide 11 (PA11), polyamide 12 (PA12), polyamide 1010 (PA1010), polyamide 1012 (PA1012), polyamide 1212 (PA1212), or a mixture thereof or a copolyamide thereof, in particular PA11 and PA12.

More particularly, said long-chain homopolyamide is chosen from: polyamide 11 (PA11), polyamide 12 (PA12), polyamide 1012 (PA1012), polyamide 1212 (PA1212), or a mixture thereof or a copolyamide thereof, in particular PA11 and PA12, and
said polyamide bearing amide units (Ba1) of the second composition is chosen from: polyamide 11 (PA11), polyamide 12 (PA12), polyamide 1012 (PA1012), polyamide 1212 (PA1212), or a mixture thereof or a copolyamide thereof, in particular PA11 and PA12.

Even more particularly, said long-chain homopolyamide is polyamide 11, and said polyamide bearing amide units (Ba1) of the second composition is polyamide 11.

In one embodiment, said first and second elements are chosen from the following constituents: a textile, a film or textured film, a foam, an injection-molded part, an extruded part, a 3D-printed part, an adhesive, a nonwoven, a web and a consolidated thermoplastic composite part, preferably from a textile, a foam, an injection-molded part, a 3D-printed part, an adhesive, a nonwoven, a web and a consolidated thermoplastic composite part.

According to one embodiment, said first and/or second element are different from a film.

According to one embodiment, said first and/or second element are different from an extruded part.

In another embodiment, said mono-material object defined above is characterized in that it consists of at least two constituents defined above and which are different.

In yet another embodiment, said mono-material object as defined above is characterized in that it comprises at least three constituents defined above, in particular different ones.

As indicated above, the first element and the second element may at least partially adhere to each other. When they adhere to each other at least partially, the first and second elements adhere to each other by bonding by means of a non-polyamide adhesive in a content ranging from 0.01% to 10% by weight, in particular from 0.1% to 4% by weight relative to the total mass of the object.

Said adhesive may be a polyurethane, acrylic, acrylonitrile, polyester, polyisoprene, polybutadiene or vinyl adhesive, preferably chosen from a polyurethane, acrylic and polyester adhesive; advantageously, it corresponds to a polyurethane adhesive.

According to another embodiment, the mono-material objects of the invention comprise less than 0.1% by weight, preferably less than 0.01% by weight, and more particularly 0% by weight, of non-polyamide adhesive.

In particular, they may comprise less than 0.1% by weight, preferably less than 0.01% by weight, and more particularly 0% by weight, of encapsulated adhesion promoter (P) comprising at least one organic molecule including at least two isocyanate functions blocked by encapsulation of said organic molecule, notably as defined in US 2011/0111208.

According to one embodiment, the mono-material objects of the invention comprise less than 0.1% by weight, preferably less than 0.01% by weight, and more particularly 0% by weight, of a dispersion of polyisocyanates in water and/or an organic solvent, in particular as defined in US 2011/0111208.

Preferably, when the mono-material objects of the invention comprise an adhesive, this is different from a dispersion in a solvent, in particular a dispersion in water and/or in an organic solvent. In particular, when the mono-material objects of the invention comprise an adhesive, this is different from a dispersion in the solvent MEK (methyl ethyl ketone) and/or a C1-C5 alkyl acetate, particularly ethyl acetate.

In particular, the mono-material objects of the invention comprise less than 0.1% by weight, preferably less than 0.01% by weight, and more particularly 0% by weight, of adhesion promoter containing a solution of polyurethane modified in MEK+ethyl acetate solvent (dry extract—30 min 150 °C=46.9% by mass of polyurethane).

Specifically, such non-polyamide adhesives should be avoided for environmental reasons, insofar as they have a certain toxicity. Such non-polyamide adhesives also have a negative impact on the recyclability of the mono-material materials according to the invention, insofar as they cannot be readily separated and/or insofar as they are crosslinked, and consequently cannot be recycled.

In particular, as indicated previously, when thermoplastic polyurethanes (TPU) are recycled, isocyanate formation can be observed by FTIR. However, isocyanates are compounds that are hazardous to health and the environment (CMR classification), the formation of which it is sought to avoid in the context of the present invention.

In one embodiment, elements 1 and 2 adhere to each other by means of a polyamide adhesive.

This may notably be a hot-melt adhesive composition comprising at least one copolyamide, such as those described in WO 2022/090665.

According to another embodiment, elements 1 and 2 adhere directly to each other, i.e. without adhesive.

Said mono-material object defined above may comprise at least one third element consisting of a third composition comprising by weight at least 50%, advantageously 70%, preferably 90%, relative to the total weight of the third element, of at least one long-chain homopolyamide or at least one long-chain copolyamide or of a copolyamide bearing amide units (Ba1) and polyether units (Ba2) or of a mixture thereof.

In one embodiment, said first and second elements are chosen from the following constituents: a textile, a film or textured film, a foam, an injection-molded part, an extruded part, a 3D printed part, an adhesive, a non-woven, a web and a consolidated thermoplastic composite part.

In another embodiment, said mono-material object defined above is characterized in that it consists of at least two constituents defined above and which are different.

In yet another embodiment, said mono-material object as defined above is characterized in that it comprises at least three constituents defined above, in particular different ones.

As indicated above, the first element and the second element may at least partially adhere to each other. When they adhere to each other at least partially, the first and second elements adhere to each other by bonding by means of a non-polyamide adhesive in a content ranging from 0.01% to 10% by weight, in particular from 0.1% to 4% by weight relative to the total mass of the object.

Said mono-material object defined above may comprise at least one third element consisting of a third composition comprising at least one long-chain homopolyamide or at least one long-chain copolyamide or at least one copolyamide bearing amide units (Ba1) and polyether units (Ba2) or a mixture thereof, said at least one copolyamide bearing amide units (Ba1) and polyether units (Ba2) being as defined above.

In one embodiment, said third composition comprises by weight at least 50%, advantageously 70%, preferably 90%, of at least one long-chain homopolyamide or at least one long-chain copolyamide or at least one copolyamide bearing amide units (Ba1) and polyether units (Ba2) or a mixture thereof, relative to the total weight of the third element.

As regards the copolyamide bearing amide units (Ba1) and polyether units (Ba2) (PEBA) of the compositions of the second and third elements

The polyether block amides (PEBA) are copolymers containing amide units (Ba1) and polyether units (Ba2), said amide unit (Ba1) corresponding to an aliphatic repeating unit chosen from a unit obtained from at least one amino acid or a unit obtained from at least one lactam, or a unit X.Y obtained from the polycondensation:
of at least one diamine, said diamine being preferentially chosen from a linear or branched aliphatic diamine, or a mixture thereof, and
of at least one dicarboxylic acid, said diacid being preferentially chosen from:
   a linear or branched aliphatic diacid, or a mixture thereof,
   said diamine and said diacid comprising from 4 to 36 carbon atoms, advantageously from 6 to 18 carbon atoms;
   said polyether units (Ba2) being obtained notably from at least one polyalkylene ether polyol, notably a polyalkylene ether diol.

PEBAs result notably from the polycondensation of polyamide blocks having reactive ends with polyether blocks having reactive ends, such as, inter alia:
1) polyamide blocks bearing diamine chain ends with polyoxyalkylene blocks bearing dicarboxylic chain ends.
2) Polyamide blocks bearing dicarboxylic chain ends with polyoxyalkylene blocks bearing diamine chain ends, obtained by cyanoethylation and hydrogenation of aliphatic α,ω-dihydroxylated polyoxyalkylene blocks referred to as polyalkylene ether diols (polyether diols).
3) Polyamide blocks bearing dicarboxylic chain ends with polyether diols, the products obtained being, in this particular case, polyetheresteramides. The copolymers of the invention are advantageously of this type.

The polyamide blocks bearing dicarboxylic chain ends originate, for example, from the condensation of polyamide precursors in the presence of a chain-limiting dicarboxylic acid.

The polyamide blocks bearing diamine chain ends originate, for example, from the condensation of polyamide precursors in the presence of a chain-limiting diamine.

The polymers having polyamide blocks and polyether blocks can also comprise randomly distributed units. These polymers can be prepared by the simultaneous reaction of the polyether and of the precursors of the polyamide blocks.

For example, it is possible to react polyether diol, polyamide precursors and a chain-limiting diacid. A polymer is obtained essentially having polyether blocks and polyamide blocks of very variable length, but also the various reagents that have reacted randomly, which are distributed randomly (statistically) along the polymer chain.

It is also possible to react polyetherdiamine, polyamide precursors and a chain-limiting diacid. A polymer is obtained essentially having polyether blocks and polyamide blocks of very variable length, but also the various reagents that have reacted randomly, which are distributed randomly (statistically) along the polymer chain.

### Amide Unit (Ba1):

The amide unit (Ba1) corresponds to an aliphatic repeating unit as defined above.

Advantageously, the amide unit (Ba1) is chosen from polyamide 11, polyamide 12, polyamide 610, polyamide 612, polyamide 1010, polyamide 910, polyamide 613, polyamide 514, polyamide 109, polyamide 1011, polyamide 516, polyamide 615, polyamide 913, polyamide 129, polyamide 1012, in particular polyamide 11.

More advantageously, the amide unit (Ba1) is chosen from polyamide 11 and polyamide 12, in particular polyamide 11.

The amide unit (Ba1) comprises less than 20%, advantageously less than 10%, preferably less than 5%, notably less than 2% by weight of polyamide having a C/N ratio of less than or equal to 8.

### Polyether Unit (Ba2):

The polyether units are notably derived from at least one polyalkylene ether polyol, in other words, the polyether units are formed from at least one polyalkylene ether polyol.

In this embodiment, the term “at least one polyalkylene ether polyol” means that the polyether units consist exclusively of alcohol chain ends and thus cannot be a compound of the polyetherdiamine triblock type.

The composition of the invention is thus free of polyetherdiamine triblocks.

According to one embodiment, the copolyamide bearing amide units (Ba1) and polyether units (Ba2) of the second composition predominantly comprises, i.e. to more than 50% by weight, relative to the total weight of said polyether units, a polyether unit (Ba2) having a C/O ratio of greater than 3, for example greater than 3.5.

The copolyamide bearing amide units (Ba1) and polyether units (Ba2) of the second composition may notably comprise at least 80% by weight, or even 100% by weight, relative to the total weight of said polyether units, of a polyether unit (Ba2) having a C/O ratio greater than 3, for example greater than 3.5.

Advantageously, the polyether units (Ba2) are chosen from polyethylene glycol (PEG), polypropylene glycol (PPG), polytrimethylene glycol (PO3G), polytetramethylene glycol (PTMG) and mixtures thereof or copolymers thereof, in particular PTMG.

According to one embodiment, the polyether unit (Ba2) of the copolyamide bearing amide units (Ba1) and polyether units (Ba2) present in the second element of the mono-material object of the invention comprises less than 20% by weight, preferably less than 10% by weight, advantageously less than 5% by weight, notably less than 2% of copolyamide bearing amide units (Ba1) and short-chain polyether units (Ba2), i.e. polyether units having a C/O ratio less than or equal to 3, notably less than or equal to 2.

For the purposes of the invention, the C/O ratio corresponds to the ratio between the number of carbon atoms and the number of nitrogen atoms in the polyether unit.

According to one embodiment, the polyether unit (Ba2) of the copolyamide bearing amide units (Ba1) and polyether units (Ba2) present in the second element of the mono-material object of the invention comprises less than 20% by weight, preferably less than 10% by weight, advantageously less than 5% by weight, notably less than 2% by weight of polyethylene glycol (PEG), polypropylene glycol (PPG) and/or polytrimethylene glycol (PO3G), in particular polyethylene glycol (PEG).

According to one embodiment, a mono-material object of the invention comprises less than 20% by weight, preferably less than 10% by weight, for example less than 5% by weight, for example less than 3% by weight, in particular 0% by weight, relative to its total weight, of copolyamide bearing amide units (Ba1) and short-chain polyether units (Ba2), i.e. polyether units having a C/O ratio of less than or equal to 3, in particular less than or equal to 2.

In one embodiment, the (Ba2) unit is free of (i.e. comprises less than 0.1% by weight, preferably 0% by weight) polyethylene glycol (PEG), polypropylene glycol (PPG) and/or polytrimethylene glycol (PO3G), in particular polyethylene glycol (PEG).

Advantageously, a low water uptake and thus a lower density of the mono-material objects of the invention is observed during use when the latter comprises little or even no copolyamide bearing amide units (Ba1) and short-chain polyether units (Ba2), i.e. polyether units having a C/O ratio of less than or equal to 3, notably less than or equal to 2.

The number-average molecular mass (Mn) of the polyether blocks is advantageously from 200 to 4000 g/mol, preferably from 250 to 2500 g/mol, notably from 300 to 1100 g/mol.

The PEBA may be prepared via the following process in which:
in a first step, the polyamide blocks (Ba1) are prepared by polycondensation
   of the lactam(s), or
   of the amino acid(s), or
   of the diamine(s) and of the dicarboxylic acid(s); and where appropriate, of the comonomer(s) chosen from lactams and α,ω-aminocarboxylic acids;
   in the presence of a chain limiter chosen from dicarboxylic acids; and then
in a second step, the polyamide blocks (Ba1) obtained are reacted with the polyether blocks (Ba2), in the presence of a catalyst.

The two-step general method of preparation for the copolymers of the invention is known and is described for example in French patent FR 2 846 332 and European patent EP 1 482 011.

The reaction for forming block (Ba1) is usually performed between 180 and 300 °C, preferably from 200 to 290 °C, and the pressure in the reactor becomes established at between 5 and 30 bar and is maintained for about 2 to 3 hours. The pressure is reduced slowly while returning the reactor to atmospheric pressure and the excess water is then distilled off, for example over one or two hours.

Once the polyamide bearing carboxylic acid end groups has been prepared, the polyether and a catalyst are then added. The polyether may be added in one or more portions, as may the catalyst. According to an advantageous form, the polyether is first added; the reaction of the OH end groups of the polyether and of the COOH end groups of the polyamide begins with formation of ester bonds and elimination of water. As much water as possible is removed from the reaction medium by distillation, then the catalyst is introduced to complete the linking of the polyamide blocks and the polyether blocks. This second step is performed with stirring, preferably under a vacuum of at least 15 mmHg (2000 Pa), at a temperature such that the reagents and the copolymers obtained are in molten form. For example, this temperature may be between 100 and 400 °C and more commonly between 200 and 300 °C. The reaction is monitored by measuring the torque exerted by the molten polymer on the stirrer or by measuring the electrical power consumed by the stirrer. The end of the reaction is determined by the target torque or power value.

It is also possible to add, during synthesis, at the moment deemed to be the most opportune, one or more molecules used as antioxidant, for example Irganox® 1010 or Irganox® 245.

It is also possible to consider the PEBA preparation process which is such that all the monomers are added at the start, i.e. in a single step, to bring about the polycondensation:
of the lactam(s), or
of the amino acid(s), or
of the diamine(s) and of the dicarboxylic acid(s); and, where appropriate, of the other polyamide comonomer(s);
   in the presence of a chain limiter chosen from dicarboxylic acids;
   in the presence of the (Ba2) (polyether) blocks;
   in the presence of a catalyst for the reaction between the flexible (Ba2) blocks and the (Ba1) blocks.

Advantageously, said dicarboxylic acid is used as chain limiter, introduced in excess relative to the stoichiometry of the diamine(s).

Advantageously, a derivative of a metal selected from the group formed of titanium, zirconium and hafnium, or a strong acid such as phosphoric acid, hypophosphorous acid or boric acid, is used as catalyst.

The polycondensation may be performed at a temperature from 240 to 280 °C.

Generally speaking, the known copolymers bearing ether and amide units consist of semicrystalline linear, aliphatic polyamide blocks (for example Pebax from Arkema).

In one embodiment, the copolyamide bearing amide units (Ba1) and polyether units (Ba2) has a density greater than or equal to 1, in particular greater than or equal to 1.01, notably greater than or equal to 1.02, as determined according to ISO 1183-3: 1999.

In one embodiment, polyetheramines are excluded from the polyether units (Ba2).

In one embodiment, the copolyamide bearing amide units (Ba1) and polyether units (Ba2) present in the first composition constituting the first element of the mono-material object of the invention has a Shore D hardness of less than or equal to 50 D, notably less than or equal to 45 D.

### As Regards the Mono-Material Object

It consists of at least two elements: said at least one first element defined here as (E1) and said at least one second element defined here as (E2).

In a first variant, it consists of two said elements: E1/E2.

Element E1 can adhere to element E2 at least partially; in particular, E1 and E2 adhere at least partially and notably E1 and E2 adhere totally, in particular by means of an adhesive.

The mono-material object is then chosen from those described above.

In a second variant, it consists of more than two elements: E1/(E1)n/E2/(E2)m, n and m being from 0 to 5 and when n=0, then m is greater than 0 and when m=0, then n is greater than 0.

Needless to say, when two elements E1 or E2 are side by side, they can adhere together at least partially.

In one embodiment, the homopolyamides or copolyamides of the E1 element and the copolyamides of the E2 element comprise an identical monomer, for example 11-aminoundecanoic acid, notably at least 5% by weight of an identical monomer relative to the sum of the constituents of said homopolyamide or copolyamide, advantageously at least 10%, preferably at least 30%.

In one embodiment, the homopolyamides or copolyamides of element E1 and the copolyamides of element E2 consist of a monomer having an identical C/N ratio, notably at least 5% by mass of a monomer having an identical C/N relative to the sum of the constituents of said homopolyamide or copolyamide, advantageously 10%, preferably 30%.

In a third variant, it may consist of more than two elements: said at least one first element defined herein as (E1) and said at least one second element defined herein as (E2) and said third element defined herein as E3.

In one embodiment, it consists of three elements: E1/E2/E3 or E1/E3/E2 or E3/E1/E2.

Element E1 can adhere to element E2 at least partially; in particular, E1 and E2 adhere at least partially and notably E1 and E2 adhere totally, in particular by means of an adhesive.

Element E2 can adhere to element E3 at least partially; in particular, E2 and E3 adhere at least partially and notably E2 and E3 adhere totally, in particular by means of an adhesive.

It would not be outside the context of the invention if at least one other element E1 and/or E2 and/or E3 were present in said mono-material object.

In a first variant, the first element is of non-recycled origin.

In a second variant, the second element is of non-recycled origin.

In a third variant, the third element, if present, is of non-recycled origin.

In a fourth variant, the first element and the second element are of non-recycled origin.

In a fifth variant, the first element and the third element when they are present are of non-recycled origin.

In a sixth variant, the second element and the third element when they are present are of non-recycled origin.

In a seventh variant, the first element, the second element and the third element when present are of non-recycled origin.

In an eighth variant, the first element is of at least partially recycled origin.

In a ninth variant, the second element is of at least partially recycled origin.

In a tenth variant, the third element, if present, is of at least partially recycled origin.

In an eleventh variant, the first element and the second element are of at least partially recycled origin.

In a twelfth variant, the first element and the third element when they are present are of at least partially recycled origin.

In a thirteenth variant, the second element and the third element when they are present are of at least partially recycled origin.

In a fourteenth variant, the first element, the second element and the third element when they are present are of at least partially recycled origin.

The term “at least partially recycled” means that there is at least 10%, 20%, 30%, 40%, 50%, 60%, 70%, 80%, 90% recycled composition in said element, said recycled composition itself comprising at least 10%, 20%, 30%, 40%, 50%, 60%, 70%, 80%, 90% long-chain homopolyamide or copolyamide or copolyamide bearing amide units (Ba1) and polyether units (Ba2) of recycled origin.

In one embodiment, when the mono-material consists of three or more elements, said composition of the third element comprises at least one long-chain homopolyamide or at least one long-chain copolyamide.

In another embodiment, when the mono-material consists of three or more elements, said composition of the third element (E3) comprises at least one copolyamide bearing amide units (Ba1) and polyether units (Ba2).

In yet another embodiment, when the mono-material consists of three or more elements, said composition of the third element comprises a blend of at least one long-chain homopolyamide or at least one long-chain copolyamide and at least one copolyamide bearing amide units (Ba1) and polyether units (Ba2).

In another embodiment, the composition of the first element (E1) comprises a single long-chain homopolyamide or at least one long-chain copolyamide.

In another embodiment, the composition of the second element (E2) comprises a single copolyamide bearing amide units (Ba1) and polyether units (Ba2).

In another embodiment, the composition of the third element (E3), if present, comprises a single long-chain homopolyamide or at least one long-chain copolyamide.

In another embodiment, the composition of the third element (E3) if present comprises a single copolyamide bearing amide units (Ba1) and polyether units (Ba2).

In another embodiment, the composition of the first element (E1) comprises a single long-chain homopolyamide or at least one long-chain copolyamide and the composition of the second element (E2) comprises a single copolyamide bearing amide units (Ba1) and polyether units (Ba2).

In another embodiment, the composition of the first element (E1) comprises a single long-chain homopolyamide or at least one long-chain copolyamide and the composition of the second element (E2) comprises a single copolyamide bearing amide units (Ba1) and polyether units (Ba2) and the composition of the third element (E3) if present comprises a single long-chain homopolyamide or at least one long-chain copolyamide.

In another embodiment, the composition of the first element (E1) comprises a single long-chain homopolyamide or at least one long-chain copolyamide and the composition of the second element (E2) comprises a single copolyamide bearing amide units (Ba1) and polyether units (Ba2) and the composition of the third element (E3) if present comprises a single copolyamide bearing amide units (Ba1) and polyether units (Ba2).

According to another aspect, the present invention relates to a process for manufacturing a mono-material object as defined above, comprising the steps consisting in:
providing a first element consisting of a first composition comprising by weight at least 30%, notably at least 50%, particularly at least 70%, more particularly at least 90%, relative to the total weight of the first element, of at least one long-chain homopolyamide or at least one long-chain copolyamide, as defined above,
providing a second element consisting of a second composition comprising by weight at least 30%, notably at least 50%, particularly at least 70%, more particularly at least 90%, relative to the total weight of the second element, of at least one copolyamide bearing amide units (Ba1) and polyether units (Ba2), as defined above,
assembling the elements of the object by means of an adhesive, where appropriate, to form the finished or semi-finished object.

In one embodiment, the process defined above comprises an additional step before assembly of providing a third element consisting of a third composition comprising by weight at least 30%, notably at least 50%, particularly at least 70%, more particularly at least 90%, relative to the total weight of the third element, of at least one long-chain homopolyamide or at least one long-chain copolyamide, as defined above, or at least one copolyamide bearing amide units (Ba1) and polyether units (Ba2) or a mixture of the two.

In the case of a semi-finished object, a step of adding other elements which cannot be recycled via the process of the invention but which are preferably readily separable from the elements of the invention, for example the electronics of a watch, is performed.

According to yet another aspect, the present invention relates to a process for recycling an object as defined above, comprising the steps consisting in:
(a) providing the used object,
(b) optionally separating the elements of the object which are not recyclable in said process,
(c) optionally cleaning the used object from step (a) or (b),
(d) optionally first grinding of the used object of step (a) or (b), or of step (c) when the cleaning of step (c) is performed so as to obtain a first ground material,
(e) optionally washing the first ground material when the cleaning of step (c) is not performed,
(f) grinding the used object from step (a) and/or (b) and/or (c) and/or (d) and/or (e) so as to obtain a first ground material or a second ground material in the case where a first grinding in step (d) has been performed,
(g) heating the ground material from step (f) until it melts,
(h) optionally compounding and
(i) extruding or injection-molding the molten mass.

The first and/or second grinding may or may not take place before or after cleaning.

Cleaning is performed by means of compressed air, in particular under pressure, or by means of hot water or water vapor from said structure.

Cleaning with compressed air allows non-polymeric particles such as earth, sand or dust to be removed from said used object.

Cleaning with hot water or steam allows the water-soluble matter of said used object to be at least partially dissolved and removed to obtain the other constituents of said used object.

The temperature of the hot water or water vapor is from 70 °C to 150 °C, in particular from 70 °C to 120 °C.

The hot water may have a pH of between 1 and 12.

Compounding step (h) allows the addition of an impact modifier and/or a filler and/or an additive and/or a plasticizer.

If step (h) is performed, then the material obtained after said step (h) is in the form of granules for subsequent extrusion or injection molding.

The term “used object” denotes an object which is no longer new, which has already been used or of which use has already been made, but in no case denotes a post-industrial object which would be recycled without having been used or of which no use has been made. The term “used object” thus covers in particular an aged object.

In another embodiment, the present invention relates to a recycling process as defined above, also comprising the step of:
(j) adding new material to the ground material of the used object before or after step (f) or after step (g).

The term “new material” denotes both another polymer, in particular another polyamide, in particular a polyamide with a C/N<8, and also fillers and additives.

The mono-material object has at least one dimension (chosen from length, width and thickness), preferably at least two dimensions (chosen from length, width and thickness), or even all three dimensions, greater than 1 mm, preferably greater than 2 mm, advantageously greater than 3 mm. Doing so allows better recyclability, in particular by grinding and/or compounding.

### As Regards the Additives:

The additive is optional and comprises from 0% to 20%, in particular from 0.1% to 5%, by weight.

The additive is chosen from dyes, stabilizers, plasticizers, surfactants, nucleating agents, pigments, brighteners, antioxidants, lubricants, flame retardants, natural waxes, impact modifiers, additives for laser marking, and mixtures thereof.

According to one embodiment, a mono-material object of the invention, and in particular the first composition constituting the first element and/or the second composition constituting the second element, comprises less than 2% by weight of carbon black, preferably less than 1% by weight of carbon black, preferably less than 0.1% by weight of carbon black, relative to its total weight. Advantageously, a mono-material object of the invention, and in particular the first composition constituting the first element and/or the second composition constituting the second element, is free of (i.e. comprises 0% by weight of) carbon black, relative to its total weight.

### As Regards the Fillers:

As regards the fillers, these are reinforcing fibers, which are notably fibers of mineral, organic or plant origin.

Said reinforcing fiber may or may not be sized.

Said reinforcing fibre may thus comprise up to 0.1% by weight of a material of organic nature (thermosetting or thermoplastic resin type) known as sizing.

Mention may be made, among the fibers of mineral origin, of carbon fibers, glass fibers, basalt fibers or basalt-based fibers, silica fibers or silicon carbide fibers, for example. Mention may be made, among the fibers of organic origin, of fibers based on thermoplastic or thermosetting polymer, such as semiaromatic polyamide fibers, aramid fibers or polyolefin fibers, for example. Preferably, they are based on an amorphous thermoplastic polymer and have a glass transition temperature Tg which is greater than the Tg of the constituent thermoplastic polymer or polymer blend of the preimpregnation matrix when the polymer or blend is amorphous, or which is greater than the Tm of the constituent thermoplastic polymer or polymer blend of the preimpregnation matrix when the polymer or blend is semicrystalline. Mention may be made, among the fibers of plant origin, of natural fibers based on flax, hemp, lignin, bamboo, silk, in particular spider silk, sisal, and other cellulose fibers, in particular viscose fibers. These fibers of vegetable origin can be used pure, treated or else coated with a coating layer, for the purpose of facilitating the adhesion and the impregnation of the thermoplastic polymer matrix.

Preferably, said reinforcing fiber is chosen from glass fibers, carbon fibers, basalt fibers and basalt-based fibers.

Advantageously, said reinforcing fiber is chosen from carbon fibers and glass fibers.

In one embodiment, the reinforcing fibers present in a) are glass fibers.

The glass fibers may be of circular or non-circular cross section.

A fiber of circular cross section is defined as a fiber having at any point on its circumference an equal distance to the center of the fiber and therefore represents a perfect or near-perfect circle.

Any glass fiber that does not have this perfect or near-perfect circle is therefore defined as a fiber of non-circular cross section.

Examples of fibers of non-circular cross section, without being limited thereto, are non-circular fibers, having for example an elliptical, oval or cocoon shape, star-shaped fibers, flake-shaped fibers, flat fibers, cruciforms, a polygon and a ring.

The glass fiber may be:
either of circular cross section with a diameter of from 4 m to 25 m, preferably from 4 to 15 μm;
or of non-circular cross section with an L/D ratio (L representing the largest dimension of the cross section of the fiber and D the smallest dimension of the cross section of said fiber) of from 2 to 8, in particular from 2 to 4. L and D can be measured by scanning electron microscopy (SEM).

Advantageously, the glass fibers are circular.

The glass fibers are notably of type E, R, S2 or T. Advantageously, the glass fibers are of type E.

In another embodiment, the fillers are present from 0 to 65%.

In one embodiment, the fillers are recycled.

In the case of fillers comprising glass, they may notably be manufactured from industrial production waste or post-consumer glass.

The carbon fibers may, for example, come from the cutting of reels of expired long fibers, in particular carbon fibers for aeronautics.

Advantageously, the fillers are chosen from glass fibers, in particular circular glass fibers, and carbon fibers, in particular glass fibers, notably circular glass fibers.

According to another aspect, the present invention relates to a recycled polyamide composition that can be obtained via the process as defined above.

According to yet another aspect, the present invention relates to a composition comprising by weight:
from 30% to 100%, advantageously from 50% to 99%, of recycled polyamide from the mono-material objects defined above,
from 0 to 70% of virgin polyamides chosen from homopolyamides, in particular long-chain homopolyamides, copolyamides, in particular long-chain copolyamides, and PEBAs; advantageously, the virgin polyamide is a homopolyamide, in particular a long-chain homopolyamide,
from 0 to 65% of fillers,
0 to 20% of additives, in particular from 0.1% to 5%,
the sum of the constituents being equal to 100%,
said recycled polyamide having functions resulting from oxidation reactions chosen from primary amide functions, nitriles, chain-end methyl groups, alkenes, formamides, imides, carboxylic acids and alcohols and mixtures thereof, in a mole ratio relative to the amide functions which is greater than that of the same polyamide constituting an unused object which has never yet been used.

The term “recycled polyamide derived from the mono-material objects as defined above” is intended to denote a polyamide derived from a mono-material object which is no longer new, which has already been used or of which use has already been made, but in no case denotes a polyamide derived from a post-industrial object which would be recycled without having been used or of which use has not been made. In contrast to a “virgin” polyamide, a “recycled” polyamide in particular covers an aged polyamide.

When a mono-material object is used, new species resulting from oxidation mechanisms, notably of the amide functions and/or of methylene a to said amide functions, such as imide functions, carboxylic acids, primary amides and alcohols, are seen in the polyamides constituting said mono-material objects.

Said functions are seen as a result of UV radiation or heat or as a result of a reaction with a compound with which said object is in contact. For example, gasoline, antisun cream, lubricants, etc.

Said functions may be detected by infrared or NMR spectrometry.

Thus, the absorption band from 1700 to 1740 cm⁻¹ corresponds to an imide, that from 1680 to 1720 cm⁻¹ to the carbonyl of the carboxylic acid and that from 3580 to 3670 cm⁻¹ corresponds to the alcohol function of the carboxylic acid.

The absorption band from 3580 to 3670 cm⁻¹ corresponds to the free alcohol function.

The amide function is characterized firstly by a pair of absorption bands from 3100 to 3500 cm⁻¹ and from 1560 to 1640 cm⁻¹ which corresponds to the NH group of the amide, and secondly by the absorption band from 1650 to 1700 cm⁻¹ which corresponds to the carbonyl group of the amide.

In a first variant, said composition comprises by weight:
from 50% to 70% of recycled polyamide from the mono-material objects defined above, from 30% to 50% of virgin polyamides chosen from homopolyamides, in particular long-chain homopolyamides, copolyamides, in particular long-chain copolyamides, and PEBAs; advantageously, the virgin polyamide is a homopolyamide,
0 to 20% of additives, in particular from 0.1% to 5%,
the sum of the constituents being equal to 100%.

In a second variant, said composition comprises by weight:
from 30% to 50% of recycled polyamide from the mono-material objects defined above,
from 0 to 65% of virgin polyamides chosen from homopolyamides, in particular long-chain homopolyamides, copolyamides, in particular long-chain copolyamides, and PEBAs; advantageously, the virgin polyamide is a homopolyamide, in particular a long-chain homopolyamide,
from 5 to 60% of fillers,
0 to 20% of additives, in particular from 0.1% to 5%,
the sum of the constituents being equal to 100%.

In a third variant, said composition comprises by weight:
from 60% to 80% of recycled polyamide from the mono-material objects defined above,
from 0 to 20% of virgin polyamides chosen from homopolyamides, in particular long-chain homopolyamides, copolyamides, in particular long-chain copolyamides, and PEBAs; advantageously, the virgin polyamide is a homopolyamide, in particular a long-chain homopolyamide,
from 20 to 40% of fillers,
0 to 20% of additives, in particular from 0.1% to 5%,
the sum of the constituents being equal to 100%.

In a fourth variant, said composition comprises by weight:
from 40% to 60% of recycled polyamide from the mono-material objects defined above,
from 0 to 20% of virgin polyamides chosen from homopolyamides, in particular long-chain homopolyamides, copolyamides, in particular long-chain copolyamides, and PEBAs; advantageously, the virgin polyamide is a homopolyamide, in particular a long-chain homopolyamide,
from 40 to 60% of fillers,
0 to 20% of additives, in particular from 0.1% to 5%,
the sum of the constituents being equal to 100%.

In one embodiment, in said compositions of this other aspect and of its four variants, the term “comprises” is replaced with the term “consists of”.

The compositions of these four variants and the embodiments thereof are compositions that are particularly suitable for the embodiment in which the mono-material object defined above is characterized in that only one of the two compositions comprises a filler, the other being devoid thereof.

The recycled polyamide has distinctive features, and notably new species resulting from oxidizing mechanisms, when it is derived from objects as defined previously.

For the purposes of the invention, the term “new species resulting from oxidizing mechanisms” is intended to denote formate functions, chain-end methyl groups, primary amides, nitriles, alkenes, formamides, carboxylic acids, aldehydes, imides and alcohols which may be seen in the recycled polyamide of the invention.

The recycled polyamide of the present invention has functions resulting from oxidation reactions chosen from formate functions, chain-end methyl groups, primary amides, nitriles, alkenes, formamides, carboxylic acids, aldehydes, imides and alcohols.

According to a preferred embodiment of the invention, the recycled polyamide of the invention has functions resulting from oxidation reactions chosen from formate functions, chain-end methyl groups, primary amides and nitriles.

According to a preferred embodiment of the invention, the recycled polyamide of the invention has functions resulting from oxidation reactions chosen from formate functions and chain-end methyl groups in a higher mole ratio relative to secondary amide functions than that of the same virgin polyamide.

These functions may be identified and quantified using infrared and/or proton or carbon NMR spectroscopy.

The NMR measurements may be performed in an HFIP/CD2Cl2 mixture. For example, 20 mg of polymer may be dissolved in 0.7 mL of solvent with an HFIP/CD2Cl2 ratio of ⅓. The dichloromethane (CD2Cl2)/trifluoroacetic anhydride (ATFA) mixture may also be used.

This method is described in the doctoral thesis by E. Goncalves in chapter 11.2.3 published in 2011, incorporated by reference. Analyses in these two solvents allow the identification of a majority of functions formed during the life of the polyamide.

Thus, by way of example, in infrared spectroscopy, the absorption band from 1700 to 1740 cm⁻¹ corresponds to an imide, that from 1680 to 1720 cm⁻¹ to the carbonyl of the carboxylic acid and that from 3580 to 3670 cm⁻¹ corresponds to the alcohol function of the carboxylic acid.

The absorption band from 3580 to 3670 cm⁻¹ corresponds to the free alcohol function.

The amide function is characterized firstly by a pair of absorption bands from 3100 to 3500 cm⁻¹ and from 1560 to 1640 cm⁻¹ which corresponds to the NH group of the amide, and secondly by the absorption band from 1650 to 1700 cm⁻¹ which corresponds to the carbonyl group of the amide.

The absorption bands at 1180 and 1723 cm⁻¹ correspond to the formates. The bands at 900 and 1660 cm⁻¹ correspond to the alkenes.

For example, the degradation of polyethers included in polyamide elastomers, notably PEBAs, can be quantified by infrared spectroscopy by comparing the ratio between the intensities of the bands at 1111 cm⁻¹ (vibration of the C—O bond of the ether group) or at 2791 cm⁻¹ (CH2 α to the ether function) and the band at 1725 cm⁻¹ (carbonyl function).

Quantification by NMR is performed, for example, by comparing the intensity of the lines of the functions not present in the virgin polymer with the lines corresponding to the CH2 α to the amide, ether or other CH2 functions in the context of proton NMR. In carbon NMR, the intensity of the lines of the functions formed during the life of the polymer is compared to the intensity of the lines of the amide or CH2 carbons.

Some of the functions mentioned above may, for example, be observed in 13C NMR in HFIP/CD2Cl2 solvent. Thus, the line at 36 ppm corresponds to the CH2 α to the primary amide, and that at 34 ppm corresponds to the CH2 α to the carboxylic acid. These species may be quantified by integrating the area under the lines and comparing them with the area under the 37.1 ppm line corresponding to the secondary amide. Similarly, the lines corresponding to the carbonyl groups of the primary amide, carboxylic acid and secondary amide functions are observed at 181.2 ppm, 179.6 ppm and 177.4 ppm, respectively. The line at 16.7 ppm corresponds to the CH2 α to the nitrile group. The formamide group gives chemical shifts at 163.0 ppm and 166.3 ppm.

Other functions mentioned above may be observed in proton NMR (¹H NMR) in HFIP/CD2Cl2 solvent as described above. The line for the formamide CHO groups emerges at 7.92 and 8.01 ppm. The line corresponding to the CH2 groups a to the primary amides may be observed at 2.30 ppm. The 0.9 ppm line corresponds to the CH3 groups of the CH3-(CH2)n type. The line at 2.40 ppm corresponds to the CH2 α to the nitrile function. The line corresponding to the proton of the formate function is observed at 8.1 ppm. The line corresponding to the proton of the aldehyde function is observed at 9.7 ppm. Similar to what is described for carbon NMR, the ratios of new functions relative to secondary amides may be determined by integrating the area under the lines and comparing them to the area under the line corresponding to the CH2 α to the secondary amide (2.20 ppm) or to the area under the line corresponding to the CONH proton of the secondary amide (6.0-6.1 ppm).

According to any one of the embodiments of the invention, in a recycled polyamide of the invention, the mole ratio of the functions resulting from oxidation reactions relative to the secondary amide functions is between 0.0005 and 0.3.

According to any one of the embodiments of the invention, in a recycled polyamide of the invention, the mole ratio of formate functions to secondary amide functions is between 0.0005 and 0.2, notably between 0.001 and 0.08, in particular between 0.005 and 0.05.

According to any one of the embodiments of the invention, in a recycled polyamide of the invention, the mole ratio of the chain-end methyl groups to the secondary amide functions is between 0.0005 and 0.2, notably between 0.001 and 0.08, in particular between 0.005 and 0.05.

According to any one of the embodiments of the invention, in a recycled polyamide of the invention, the mole ratio of the primary amide functions to the secondary amide functions is between 0.0005 and 0.1, notably between 0.001 and 0.08, in particular between 0.005 and 0.05.

Needless to say, as a function of the waste products and the exposure to which they have been subjected, one or more functions resulting from oxidizing reactions may be present.

In one embodiment, said mole ratio of the functions resulting from oxidation reactions relative to the secondary amide functions is from 1/10 000 to 1/20.

The concentrations may be measured by proton NMR in dichloromethane-d2, with the addition of HFIP (hexafluoroisopropanol) to dissolve the polyamide.

In a first variant, said mole ratio of imide functions is from 1/1000 to 1/20, notably from 1/500 to 1/20, in particular from 1/200 to 1/50.

In a second variant, said mole ratio of carboxylic acid functions is from 1/5000 to 1/20, notably from 1/3000 to 1/50, very advantageously from 1/500 to 1/15.

In a third variant, said mole ratio of alcohol functions is from 1/1000 to 1/20, advantageously from 1/1000 to 1/25 and very advantageously from 1/200 to 1/50.

In a fourth variant, said mole ratio of primary amide functions relative to the secondary amide functions is from 1/2000 to 1/20, advantageously from 1/1000 to 1/100 and very advantageously from 1/1000 to 1/500.

In a fifth variant, said mole ratio of nitrile functions relative to the secondary amide functions is from 1/1000 to 1/20, advantageously from 1/500 to 1/15 and very advantageously from 1/100 to 1/10.

In a sixth variant, said mole ratio of chain-end methyl functions relative to the secondary amide functions is from 1/5000 to 1/50, advantageously from 1/2000 to 1/100 and very advantageously from 1/1000 to 1/200.

Needless to say, as a function of the used mono-material objects and of the exposure to which they have been subjected, one or more functions resulting from oxidizing reactions may be present.

The composition also advantageously comprises residues of stabilizers chosen from phenols, quinones, stilbenequinones and phosphite.

The recycled polyamide advantageously comprises alkyl chain ends with a carbon number (between 1 and 18) which is greater than that of a virgin PA. Advantageously, the alkyl chain end content is between 1 ppm and 0.5%.

According to another aspect, the present invention relates to the use of a composition as defined above for the manufacture of objects, in particular mono-materials.

Said mono-material object thus manufactured from used mono-material object can itself be recycled according to the process of the invention at least once, in particular from 1 to 10 times.

### BRIEF DESCRIPTION OF THE FIGURE

FIG. 1 shows the CH2CO areas of the various secondary amide, primary amide and carboxylic acid functions in ¹³C NMR in a solvent mixture with an HFIP/CD2Cl2 ratio of 1/3.

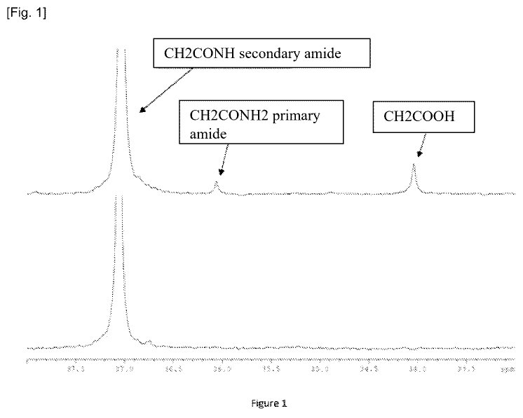

Top spectrum: PA 11 casing of an electronic watch worn for five years on the arm all day long, and bottom spectre: PA 11 based on 100% virgin material.

### EXAMPLES

The casing and bracelet of the electronic watches EC1 to EC3 and EI 1 to EI2 are assembled using screws. The percentages indicated are mass percentages. The screws were removed before recycling.

The compositions and the evaluation thereof are shown in Table 1.

TABLE 1

| | Electronic watch | | | | |
|---|---|---|---|---|---|
| | EI 1 | EC1 | EC2 | EI 2 | EC3 |
| Element 1: | PA 11 | PA 11 | PA 11 | PA 12 | PA 6 |
| 1.3 mm casing | 70% | 70% | 70% | 40% | 70% |
| Element 2: | PEBA No. 1 | TPU No. 1 | PEBA No. 2 | PEBA No. 1 | PEBA No. 1 |
| 1.5 mm bracelet | 30% | 30% | 30% | 40% | 30% |
| Density | 1.04 | 1.08 | >1.08 | 1.03 | >1.08 |
| Modulus (MPa) | 711 | 733 | Not tested | 660 | Not tested |

PA 11: homopolyamide 11 having 45 μeq/g of NH2 chain ends and 40 μeq/g of COOH chain ends. The inherent viscosity of this polyamide is 1.46.
PA 12: homopolyamide 12 having 25 μeq/g of NH2 chain ends and 65 μeq/g of COOH chain ends. The inherent viscosity of this polyamide is 1.21.
PA 6: homopolyamide 6 having 24 μeq/g of NH2 chain ends and 65 μeq/g of COOH chain ends. The inherent viscosity of this polyamide is 1.42.
PEBA No. 1: PEBA copolymer comprising PA 11 blocks with a number-average molar mass of 1000 g/mol and flexible PTMG blocks with a number-average molar mass of 1000 g/mol and a hardness of 40 Shore D. The inherent viscosity of this copolymer is 1.35.
PEBA No. 2: PEBA copolymer comprising PA 6 blocks with an average molar mass of 1500 g/mol and flexible PEG blocks with a number-average molar mass of 1500 g/mol and a hardness of 30 Shore D. The inherent viscosity of this copolymer is 1.40.
TPU No. 1: TPU with rigid blocks based on 4,4′-MDI (4,4′-diphenylmethylene diisocyanate) and 1,4-BDO (1,4-butanediol) and with flexible polyester blocks based on adipic acid and butanediol, with a hardness of 85 Shore A.

The inherent viscosities are determined in m-cresol according to the standard ISO 307:2007 but with a change of solvent (use of m-cresol instead of sulfuric acid and the temperature being 20 °C).

The EC1 and EI 1 objects were ground to a size of less than 30 mm and then compounded in an 18 mm twin-screw extruder at a flow rate of 5 kg/h and a temperature of 250 °C so as to obtain granules for evaluating the properties obtained during the second life of the material.

The granules thus obtained are then injection-molded using a Battenfeld BA800 CDC press to manufacture ISO 527 1A test specimens. The following parameters were applied during the injection:
Barrel temperature: 240 °C.
Nozzle temperature: 260 °C.
Mold temperature: 30 °C.
Cycle time: 60 seconds.

The tensile modulus at 23 °C is measured according to the standard ISO 527-1A.

the density at 23 °C is measured according to the standard ISO 1183-1 after conditioning for 15 days at 23 °C and 50% relative humidity.

The objects of the invention afford, after recycling, compositions with lower densities for an equivalent modulus.

The examples above show that the properties obtained after recycling the object according to the invention are better and thus that said objects can be recycled to manufacture new high performance objects.

1. A mono-material object comprising at least two elements:
at least one first element consisting of a first composition comprising, by weight, at least 30%, relative to the total weight of the first element, of at least one long-chain homopolyamide or of at least one long-chain copolyamide,
said at least one long-chain homopolyamide and said at least one long-chain copolyamide representing, independently of each other, a repeating unit chosen from a unit obtained from the polycondensation of at least one C4-C36 amino acid, a unit obtained from the polycondensation of at least one C4-C36 lactam and an XY unit obtained from the polycondensation:
of at least one diamine, said diamine being chosen from a linear or branched aliphatic diamine, a cycloaliphatic diamine and a semi-arylaliphatic diamine, or a mixture thereof, and of at least one dicarboxylic acid, said diacid being chosen from:
an aliphatic diacid, a cycloaliphatic diacid and an aromatic diacid,
said diamine and said diacid comprising from 4 to 36 carbon atoms,
a copolyamide bearing amide units (Ba1) and polyether units (Ba2) being excluded from said first composition,
at least one second element consisting of a second composition comprising by weight at least 30%, relative to the total weight of the second element, of a copolyamide bearing amide units (Ba1) and polyether units (Ba2)
said first and second elements being able to adhere at least partially to each other,
said at least one long-chain homopolyamide or at least one long-chain copolyamide of the first composition having a C/N ratio greater than or equal to 8, and said copolyamide of the second composition having a C/N ratio of the unit (Ba1) greater than or equal to 6, said object being to the exclusion of a monolayer or multilayer structure for transporting, distributing or storing a fluid.

2. The mono-material object as claimed in claim 1, wherein the object is chosen from an electronic article, a textile article, an optical article, a household electrical article, a cosmetic article, a sports article, a stationery article, a luggage article, a toy, furniture or motor vehicle parts.

3. The mono-material object as claimed in claim 1, wherein only one of the two compositions comprises a filler, the other being free thereof.

4. The mono-material object as claimed in claim 1, wherein at least 10% by weight of the units, constituting said at least one homopolyamide or said at least one copolyamide of the first composition and said polyamide bearing units (Ba1) of the second composition are identical.

5. The mono-material object as claimed in claim 1, wherein the first composition and the copolyamide bearing amide units (Ba1) and polyether units (Ba2) of the second composition comprise the same polyamide.

6. The mono-material object as claimed in claim 1, wherein said first and second elements are chosen from the following constituents: a textile, a film or textured film, a foam, an injection-molded part, an extruded part, a 3D-printed part, an adhesive, a nonwoven, a web and a consolidated thermoplastic composite part.

7. The mono-material object as claimed in claim 6, wherein the object comprises at least two constituents which are different.

8. The mono-material object as claimed in claim 7, wherein the object comprises at least three constituents.

9. The mono-material object as claimed in claim 1, wherein the first and second elements adhere to each other by bonding by means of a non-polyamide adhesive in a content ranging from 0.01% to 10% by weight, by weight relative to the total mass of the object.

10. The mono-material object as claimed in claim 1, wherein the object comprises at least one third element consisting of a third composition comprising
at least one long-chain homopolyamide or at least one long-chain copolyamide or at least one copolyamide bearing amide units (Ba1) and polyether units (Ba2) or a mixture thereof, said at least one copolyamide bearing amide units (Ba1) and polyether units (Ba2).

11. A process for manufacturing a mono-material object as claimed in claim 1, comprising the steps consisting in:
providing a first element consisting of a first composition comprising by weight at least 30%, relative to the total weight of the first element, of at least one long-chain homopolyamide or at least one long-chain copolyamide,
providing a second element consisting of a second composition comprising by weight at least 30%, relative to the total weight of the second element, of at least one copolyamide bearing amide units (Ba1) and polyether units (Ba2),
assembling the elements of the object by means of an adhesive, where appropriate, to form the finished or semi-finished object.

12. The process for recycling the object as defined in claim 1, comprising the steps:
(a) providing the used object,
(b) optionally separating the elements of the object which are not recyclable in said process,
(c) optionally cleaning the used object from step (a) or (b),
(d) optionally first grinding of the used object of step (a) or (b), or of step (c) when the cleaning of step (c) is performed so as to obtain a first ground material,
(e) optionally washing the first ground material when the cleaning of step (c) is not performed,
(f) grinding the used object from step (a) and/or (b) and/or (c) and/or (d) and/or (e) so as to obtain a first ground material or a second ground material in the case where a first grinding in step (d) has been performed,
(g) heating the ground material from step (f) until it melts,
(h) optionally compounding and
(i) extruding or injection-molding the molten mass.

13. The recycling process as claimed in claim 12, also comprising the step of:
(j) adding new material to the ground material of the used object before or after step (f) or after step (g).

14. A recycled polyamide composition that may be obtained via the process as claimed in claim 12.

15. A composition comprising, on a weight basis:
from 30% to 100%, of recycled polyamide from the object of claim 1,
from 0 to 70% of virgin polyamides chosen from homopolyamides;
0 to 20% of additives,
the sum of the constituents being equal to 100%,
said recycled polyamide having functions resulting from oxidation reactions chosen from primary amide functions, nitriles, chain-end methyl groups, alkenes, formamides, imides, carboxylic acids and alcohols and mixtures thereof, in a mole ratio relative to the amide functions which is greater than that of the same polyamide constituting an unused object which has never yet been used.

16. The composition as claimed in claim 15, wherein said mole ratio of functions derived from oxidation reactions relative to the secondary amide functions is from 1/10 000 to 1/20.

17. The composition as claimed in claim 15, wherein said mole ratio of imide functions relative to the secondary amide functions is from 1/1000 to 1/20.

18. The composition as claimed in claim 15, wherein said mole ratio of carboxylic acid functions relative to the secondary amide functions is from 1/5000 to 1/20.

19. The composition as claimed in claim 15, wherein said mole ratio of alcohol functions relative to the secondary amide functions is from 1/1000 to 1/20.

20. The composition as claimed in claim 15, wherein said mole ratio of primary amide functions relative to the secondary amide functions is from 1/2000 to 1/20.

21. The composition as claimed in claim 15, wherein said mole ratio of nitrile functions relative to the secondary amide functions is from 1/1000 to 1/20.

22. The composition as claimed in claim 15, wherein said mole ratio of chain-end methyl functions relative to the secondary amide functions is from 1/5000 to 1/50.

23. A method of using the composition as claimed in claim 14, for the manufacture of objects.
